(19) United States
(12) Patent Application Publication
(10) Pub. No.: US 2022/0242450 A1
(43) Pub. Date: Aug. 4, 2022

(54) METAVERSE DATA FUSION SYSTEM

(71) Applicant: ROBORACE LIMITED, London (GB)

(72) Inventors: Mikhail SOKOLOV, London (GB); Bryn BALCOMBE, London (GB)

(21) Appl. No.: 17/611,480

(22) PCT Filed: May 15, 2020
(86) PCT No.: PCT/GB2020/051198

§ 371 Date: Nov. 15, 2021

(30) Foreign Application Priority Data
May 15, 2019 (GB) 1906813.9

(51) Int. Cl. B60W 60/00; B60W 50/04

(52) U.S. Cl. CPC B60W 60/0015; B60W 50/045; B60W 2556/35; B60W 2554/4029; B60W 2552/05; B60W 2554/20; B60W 2555/60; B60W 2555/20; B60W 2552/50

(57) ABSTRACT

A real-world vehicle includes multiple data sources that generate sensor data that is spatially-mapped to a real-world region; a data fusion system is configured to fuse or integrate (i) the spatially-mapped sensor data with (ii) virtual data, that has been generated outside of the vehicle or generated independently of the operation of the vehicle, and is spatially-mapped to a virtual world. This enables a fusion of the real and virtual worlds which enables a self-driving car to interact not only with the physical world but also to virtual objects introduced into the path of the car (e.g. by a test or development engineer) to test how well the car and its autonomous driving systems cope with the virtual object.

### BACKGROUND OF THE INVENTION

### 1. Field of the Invention

This invention relates to a Metaverse Data Fusion System for use in a vehicle or a group of vehicles simultaneously; a metaverse combines virtual reality and the real-world into a unified representation of a hybrid reality. The vehicle may be an autonomous vehicle (AV) and the Metaverse Data Fusion System opens up new possibilities in not only AV software testing and design, but in AV motorsports competition and entertainment.

### 2. Description of the Prior Art

Autonomous systems (robots, self-driving cars, drones etc.) require new and efficient tools for developing, testing, proving and challenging such systems in various scenarios, especially the most complex and risky ones. This can be achieved by doing various virtual simulations, but the accuracy of many entirely virtual models that simulate real-time physics still remains insufficient.

Experiments with actual real-world vehicles on real-world test tracks or proving grounds are widely practiced to address this; for example, physical obstacles can be moved into the path of an autonomous vehicle to see how well the vehicle control systems are able to locate, identify, track and avoid the obstacle, especially when taking into account competing requirements, such as nearby kerbs, road sign. But this is expensive, slow to set-up, inconsistent and there is often physical damage, injuries, etc. when running the most extreme scenarios.

The invention also draws on the following: digital world models; augmenting images of the physical world with virtual objects; a ‘metaverse’; creating live digital replicas of real world objects or events; an augmented reality world affecting the physical world. Each of these is individually known, as outlined below.

The concept of a digital world model is not new: Every driver with a sat nav device has access to a digital twin of the physical-world upon which their real-time location can be displayed. Every robot requires a digital twin of the physical world in order to move freely and interact in real-time with dynamic objects. Techniques for simultaneous localisation and mapping (SLAM) have been around for a long time.

The concept of augmenting images of the physical world with virtual objects is not new: it is a common technique within the movie visual effects industries and is used in real-time by TV broadcasters in the creation of virtual studio sets. It is used by sports broadcasters to augment, tv advertising, world record lines in swimming or long jump, racing lines in skiing, ball flight paths in golf or 1st & 10 lines in NFL.

The concept of the metaverse is not new; a metaverse is conventionally defined as a collective virtual shared space, created by the convergence of virtually enhanced physical reality and physically persistent virtual space. It is also sometimes, although not in this specification, used to refer specifically to the combination of the internet and all virtual worlds and all converged worlds that are in existence. The term was introduced in 1992 in the science fiction novel Snow Crash, written by Neal Stephenson and the concept appeared more recently in Steven Spielberg's Ready Player One.

The concept of creating live digital replicas of real worlds is not new; it has been used for the NASCAR RaceView fan experience since 2002 and has been used to create Virtual Spectator experiences for hard to access sports such as America's Cup Yacht racing and the FIA World Rally Championship. In 2018 Virtually Live partnered with FIA Formula E to create a ghost race experience where eSports gamers compete against real world drivers in real time. It has been used in motorsport race control systems for monitoring all track activity from GPS systems located inside each car.

The concept of an augmented reality world affecting the physical world is not new; it has been used in Anki OVERDRIVE and Hot Wheels® Augmoto™ Augmented Reality Racing Track Set. Alex Liniger's self-driving overtaking research used real-world cars, controlled remotely from a digital world in which all planning, control and decision making was implemented. Large scale drone displays are often designed and planned in a virtual model which is updated in real time with real world feedback during live displays.

Data fusion systems are well known, especially in the computer vision context, where data fusion system fuse or integrate data from multiple computer vision sensors, prioritising the most reliable data and resolving conflicts between data from different sensors. The term ‘data fusion system’ in this specification should be expansively construed to cover any system that takes data from multiple sources and fuses, integrates, or otherwise combines or selectively combines them in some manner. The term ‘autonomous vehicle’ should be expansively construed to cover any vehicle sensing its environment and moving with little or no human input, and hence includes, without limitation, any vehicle at or above Level 3 SAE J3016.

### SUMMARY OF THE INVENTION

A first aspect of the invention is a data fusion system for use in a real-world vehicle, in which the vehicle includes multiple data sources that generate sensor data that is spatially-mapped to a real-world region; and in which the data fusion system is configured to fuse or integrate (i) the spatially-mapped sensor data with (ii) virtual data, that has been generated outside of the vehicle or, whether inside or outside of the vehicle, has been generated independently of the vehicle or the operation of the vehicle, and is spatially-mapped to a virtual world.

Other aspects are:

A vehicle that includes a data fusion system as defined above.

A method of developing, improving or testing a vehicle, in which the vehicle includes a data fusion system as defined above and virtual objects, events or conditions are added to the virtual world processed by the data fusion system to test how the vehicle responds to those virtual objects, events or conditions.

A vehicle that has been developed, improved or tested using the method defined above.

A game or other entertainment system, the system generating images that display or otherwise feature a vehicle that includes a data fusion system as defined above.

One implementation is the Roborace® Metaverse™; this is a fusion of the real and virtual worlds to create both unique competition formats and new entertainment experience. The foundation of the Roborace Metaverse is a shared “Metaverse World Model” which fuses data acquired in the physical world with data generated within virtual worlds. This single “Metaverse World Model” is created from real-time spatial data which enables synchronisation between real and virtual worlds. The virtual world is partly a live 3D digital twin of the physical world, however, it may include additional virtual objects whose spatial data is distributed to involved real world agents.

These real-time digital spatial foundations enable:
self-driving cars to interact with the physical and virtual worlds simultaneously;
audiences to experience the physical world in a fully immersive virtual world in remote locations;
physically present spectators to view live action with real-time augmented reality;
human drivers to experience the real-world with augmented reality displays as if inside an eSports game;
a human driver can be fully immersed in virtual world experience while controlling a real car in physical reality by wearing a VR headset;
highly accurate 3D vehicle models as well as real-time kinematics enable photorealistic visual effects inside virtual world game engines;
robot cameras to film physical cars in a fully automated way, while giving movie directors the ability plan shots within the virtual world.

Once inside the Roborace Metaverse movie directors can create an infinite array of cinematic shots and effects to enhance the both action and narration. Live TV Directors have exactly the same freedoms and, in fact, so do the remote VR audience. The physical world simply becomes a movie set, a blank canvas for real-time visual effects in styles ranging from photorealism to cartoon.

For the applications in vehicle development and motorsport competitions the virtual obstacles can be added to appear to the sensors at user-defined regions of the real-world track or route; by affecting the whole sensor system, this simulate the obstacle in every sensor of the vehicle in a consistent manner, so that the car control systems interpret the data they process as though the virtual obstacle is a real obstacle. The Metaverse platform is basically fusing the real and virtual world to make track conditions even more extreme.

As well as introducing virtual obstacles, the Metaverse platform has also introduced ‘loots’ or virtual regions that, if the real-world vehicle passes through them, triggers rewards, points or other bonuses scoring (similar in concept to the gold rings collected by Sonic the Hedgehog). To make a really entertaining experience, the loots can be positioned close to the obstacles so that there is a conflict between collecting bonus points and crashing the car etc.

The Metaverse system can be thought of as in effect tricking real-world sensors into thinking that there are actual obstacles or ‘loots’ etc in the route and seeing if the control algorithms (e.g. the autonomous driving systems) rise to the challenge of controlling the real-world car to correctly avoid them, or pass through them, or whatever is the optimal behaviour of the real-world car.

The Metaverse platform supports: Having multiple cars on the track; entirely virtual cars; cars driven by humans; fully autonomous cars; for development and testing of autonomous vehicles and robots in real, extreme and even surreal conditions; real use applications for ordinary cars (validation, testing etc of vehicles, by pushing them to extremes); new competition formats for motorsports; new entertainment experiences for public events; making the audience not just spectators but also participants—they could have the ability to introduce a loot or an obstacle.

More importantly, the fusion of all physical and virtual spatial data into the Metaverse World Model is the foundation for interaction between physical and virtual objects. Possible use cases include the following:
self-driving cars can compete against virtual cars controlled by eSports gamers safely located inside driver-in-the-loop simulators;
human drivers with augmented reality displays can compete against virtual cars controlled by eSports gamers safely located inside driver-in-the-loop simulators;
eSports gamers in simulators can directly control physical cars at various levels of control abstraction; operational, tactical and strategic depending upon communication latencies;
virtual world objects such as trucks, buses, cars, vans, motorbikes as well as vulnerable road users such as pedestrians, cyclists and animals can be injected into the metaverse world model requiring physical cars to avoid them;
virtual objects can be turned into a massively multiplayer open game where control is in the hands of competing teams, spectators and remote audience;
real-world weather will affect competitors inside the virtual world;
salt flats and tarmac lakes provide a blank canvas for creating ever changing road layouts created and manipulated within the virtual world.

The Metaverse platform can be thought of as a data exchange platform where real-time object and event information is mediated through a shared “world model” that includes:
the physical world locations of cars, the status of the traffic lights, the time of day, weather conditions, mountain roads, city roads, highways, lanes, parking bays, garages etc;
the physical world location of other robots including humanoids, robot dogs, robotic cameras, drones etc;
the location of a virtual cars, pedestrians, traffic cones, safety or overtaking zones etc;
the geometry and location of virtual roads, buildings, intersections, traffic lights etc.

The exchange of data needs to occur in real-time and, in some cases, with minimal latency. It must flow across different networks, wired and wireless, and across different transports from shared memory to Ethernet. The data must be accessible on diverse computer hardware architectures, running different operating systems under multiple programming languages. A decentralised data centric architecture using the OMG standardised Data Distribution Service (DDS) framework may be used in some environments.

The Metaverse World Model is single unified representation of global state that reconciles the differences between the “Local World Models” from individual agents. These individual agents may be physical or virtual.

Physical agents may be subject to individual constraints for size, weight, power, processing speed, memory, communication bandwidths and latencies—all of which affect architecture, performance and capabilities of their “Local World Model”.

Virtual agents may exist within a shared simulation environment where there is a single consistent “Local World Model”. Virtual agents may also be separated across multiple simulation environments all running in parallel. When running inside a simulation it's possible that shared “Local World Model” is used by all agents within that simulated world.

External software development teams ensure that an agent's “Local World Model” can be shared into the Roborace “Metaverse World Model”. For example, by doing so the “Local World Model” of an Automated or Autonomous Driving System (ADS) can be referenced against the Roborace “Metaverse World Model” for accuracy. This creates an objective measure of ADS performance, without source code interrogation, and where appropriate the results can be used to impose safety restrictions.

“Local World Models” are already present within some ADS software architectures.

The “Local World Model” continues to handle the physical reality, and the additional remote Roborace “Metaverse World Model” enables injection of virtual objects and virtual environment features prior to the planning and control phase. This ensures that real and virtual objects are both first class citizens e.g. a virtual Truck is treated identically to a real Truck during the planning and decision-making phase; or a virtual road layout can be instantly updated reconfiguring sections of the track in real-time.

By mediating the connection to the in-vehicle AR through the Roborace Metaverse World Model, objects such as virtual cars can be augmented into displays for human drivers. These renderings can also be used for augmenting real time graphics into on-board camera video feeds for transmission back to engineers and the live linear viewing experiences.

Generalising, we have an automated driving system (ADS) for a vehicle, in which the ADS includes a local world model derived from sensing the physical world around the vehicle, and in-between this local world model and the ADS Planning & Control layer sits an embedded metaverse world model system. Therefore the driving task is based upon data received from the metaverse world model which can be virtual or mediated from the local world model.

External communication to and from a remote and centralised metaverse world model enables multiple real and virtual worlds to be fused together before sharing for execution with local agents.

Optional Features:
The local world model in the ADS sends data to, and the ADS Planning and Control layer receives data from, an external fused or metaverse world model system.
The local world model in the ADS sends data to and the ADS Planning and Control layer receives data from, a fused or metaverse world model system that is an embedded portion or sub-system of the ADS.
The local world model in the ADS sends data to, and the ADS Planning and Control layer receives data from, both an external fused or metaverse world model system and also a fused or metaverse world model system that is an embedded portion or sub-system of the ADS
The metaverse world model system enables the injection of any of the following; virtual objects, virtual paths, virtual routes, into the ADS which the ADS then includes in its control and planning operations.
The local world model sends data over an OMG DDS databus or similar real-time communication middleware.
The output of the Metaverse World Model may match the expected inputs of the ADS

Planning and Control normally received from the local world model. In this mode the ADS Planning and Control has no indication whether an object is real or virtual.
The output of the Metaverse World Model may match the expected inputs of the ADS

Planning and Control normally received from the local world model with additional flags that indicate whether an object is real or virtual. In the mode the ADS Planning and Control system may be adapted to take advantage of this additional object information.

### BRIEF DESCRIPTION OF THE DRAWINGS

The invention will be described with reference to an implementation called the Roborace Metaverse platform.

FIG. 1 shows a conventional ADS software architecture resident on an autonomous or semi-autonomous vehicle;

FIG. 2 shows ADS software architecture with integrated stand-alone Metaverse Agent on a vehicle with limited programmability;

FIG. 3 shows ADS software architecture with integrated stand-alone Metaverse Agent on a fully programmable vehicle;

FIG. 4 shows ADS software architecture with integrated Metaverse Agent in a full-scale multi-agent Metaverse;

FIGS. 5 and 6 show a racing car equipped with the Metaverse Agent approaching regions that it should pass through (boxes with dashed lines) and regions it should avoid (box with solid lines);

FIG. 7 shows a real-world autonomous racing car (the Robocar® vehicle) on a race track, passing a virtual obstacle;

FIG. 8 shows the real-world autonomous Robocar® racing car colliding with the virtual obstacle.

FIG. 9 shows the real-world autonomous Robocar® racing car collecting a virtual ‘loot’ or reward.

### DETAILED DESCRIPTION

The Roborace Metaverse platform provides a coherent, mixed reality (i.e. a fusion or combination of real-world and virtual world realities) for humans and robots (e.g. autonomous vehicles, drones etc.) to run various scenarios in a semi-simulated (i.e. a fusion or combination of real-world and virtual world realities) dynamic physical system in order to solve various practical problems (e.g. testing and developing autonomous vehicle control systems and related software/firmware/hardware) with a high degree of repeatability, consistency and efficiency.

The Roborace Metaverse platform implements a fusion of the real and virtual worlds that are interconnected in a unified, multidimensional environment providing a safe, mixed or fused reality, which is coherent or consistent for both humans and machines participating in a given scenario. In this environment, the real machines (e.g. real-world vehicles or other machines) can interact with virtual objects as though they were real. Likewise, virtual machines can interact with real world objects as though they were in their virtual world.

One practical objective of this implementation is to create advanced facilities for the development and testing of autonomous vehicles and robots, not just in normal real life, but especially in extreme and even surreal conditions having altered physics (e.g. extra-terrestrial scenarios). It also allows new entertainment experiences for public events, for instance new competition formats for motorsports and eSports.

The implementation is applicable for automotive and transportation, industrial and consumer robotics, space industry, defence industry, medicine, media and entertainment, visual arts. Some illustrative examples are given further in the Practical Implementation and Use Cases sections below.

Essentially, the Metaverse platform is a complex system of distributed software and hardware components that are interconnected by low-latency connectivity protocols into a real-time data network where information about real and virtual objects, events and conditions is mediated through a shared “world model”. These components work as plug-in “infusers” attached to control data and sensor systems of the machines thus making these control data and sensor systems part of the Metaverse by seamlessly infusing (i.e. fusing or integrating) data that represents virtual objects, conditions and events into normal control and sensor data, so the machines perceive these simulated virtual elements as real, along with real elements of the underlying actual physical processes.

The Metaverse platform may in whole or part run on compute resources (software, firmware, hardware, or any combination of these) that are (i) an integral part of the vehicle when manufactured; (ii) distributed between compute resources that are an integral part of the vehicle when manufactured, and compute resources that are added to the vehicle after manufacture; (iii) compute resources that are entirely added to the vehicle after manufacture, and hence integrate into existing in-vehicle data bus and data access ports; (iv) compute resources that are entirely external, or distributed between internal and also external compute resources.

The Metaverse platform includes the following key elements, which we will describe in more detail, later in this document:

1. Metaverse World Models—shared data models for describing semi-simulated (e.g. hybrid virtual and real-world) dynamic physical systems, in order to seamlessly fuse data acquired in the physical world with data generated within a virtual world.

2. Metaverse Agents—real or virtual active objects capable of sharing their data and perceive other objects, whilst maintaining own local world models. This term also designates the software component managing integration of software and hardware components of a given object into the metaverse environment.

3. Data Distribution Framework—a complex system of data exchange methods and protocols allowing real-time signalling and coherent data distribution across the software and hardware components of a metaverse.

4. Data Infusion Framework—an extensible toolkit of reusable software and hardware components designed to provide a standard way to build and deploy real-time data infusers for various control and sensor systems, allowing seamless and accurate infusion of artificial virtual data into normal data conditioned by real physical processes.

5. Representation Framework—an extensible toolkit of reusable software integration adaptors providing immersive representation of the Metaverse to its end-users via various user interfaces, interactive platforms and devices. In the Metaverse Representation Framework, for human end-users, the Metaverse can be represented in various options starting from simple data-visualisation dashboards and ending with highly immersive tools providing an audio-visual presentation of Metaverse with additional sensory means (e.g. motion, wind, temperature, etc). So, everything becomes displayed as a fused scene on a screen or via AR or VR headset.

One feature of the Metaverse implementation is the real-time fusion of actual and simulated digital signals in the sensor and control data of sensor-enabled, connected machines and robots (we will refer to machines as ‘vehicles’, although that term should not be limited to an object for transporting people of things; it should instead be broadly construed to cover any sort of machine, such as a robot, stationary robot, self-propelled robot, drone, autonomous passenger or load carrying vehicle; semi-autonomous passenger or load carrying vehicle).

Effective coherent orchestration of the digital components across various machines acting in a certain terrain allows implementation of complex scenarios that run natural experiments, field tests, competitions or other applications, where the machines become capable of ingesting and reacting to simulated processes as though they are real processes, simultaneously with real processes. So we have a system including real (actual) and virtual (simulated) elements, all coexisting and interacting in a single environment that we refer to as the “Metaverse”.

The Metaverse implementation by its digital nature is a discrete apparatus having a finite or countable number of states characterising the underlying combined real and virtual dynamic physical system, which is modelled as an integral composition of all real and virtual “objects”, “conditions” and “events” that describe it at every time-step of its progression.

This model we refer to as the “Metaverse World Model” or “world model”. The time-step ahead computation of the next most probable state of individual objects in this metaverse is an essential task for its functioning; it enables accurate infusion of virtual data into or with real data.

In the Metaverse implementation, the next most probable state of a metaverse world object is a computed inference of its physical state in a certain time-step. It can be derived from its actual known state, considering surrounding circumstances (including actual conditions and events) and/or based on indirect information pointing out any drift in events. Different characteristics of an object's state can be computed by different appropriate procedures including, but not limited to, dead reckoning, methods of mathematical extrapolation, Kalman filtering, deep learning inference and specific problem-solving methods like Pacejka models for vehicle tyre dynamics or SLAM for localisation in unknown environments. The majority of these methods are well-known and broadly used in computational modelling and simulation. The implementation of the Metaverse platform utilises all of the methods listed above.

This Metaverse implementation also introduces the concept of data infusers, which are a key active component of the Metaverse platform that fulfil fusion of real (actual) and virtual (simulated) data into the control and sensor data of the machines. Technically, the infusers are onboard digital components connected to internal controllers and sensors of a machine via its internal communication bus, or directly as separate hardware units or as symbiotic software modules installed to its existing hardware units. Spatially-mapped data flows from the control and sensor systems up to the infusers and from there up to the world model and from there to the vehicle planning and control system (e.g. ADS system), with control signals pathways flowing in the opposite direction.

Due to the overall high complexity of this platform, given the demanding coherency and real-time control requirements, it is designed as a highly distributed and decentralized network of software and hardware digital components computing various specific functional elements and spatially-mapped fragments of the Metaverse world model.

The platform does not, in order to avoid needless computation, have to maintain in real-time a comprehensive momentary state of the whole metaverse for every component and adjacent system at every time-step. So generally, at every moment the end-to-end state of the metaverse can be indefinite. Nevertheless, each digital component controlling one or more metaverse world objects performs real-time data processing and computation of the next most probable state only for those of the controlled objects that are momentarily involved in certain actions and contexts for those actions, that together are defined in a local world model. All the other objects are processed in the deferred time regime. So, from a real-time perspective, that method gives sparse detailing of the underlying semi-simulated physical system that is sufficient to run required scenarios, while the end-to-end state progression of the whole metaverse world model becomes available after some period of time when deferred computation over the components serving that system is finally completed. The deferred computation can be omitted if such a comprehensive time trail of the evolution of the metaverse is not required for a particular application.

This approach determines the following key principles that govern the technical architecture of the Metaverse platform:
every component consumes and produces as little data as acceptable for its functioning and interoperation with adjacent components;
there is a predominantly lazy computational evaluation of each object's states;
there is no predetermined system-wide clock and frequency and the components maintain their data sampling rates and resolution independently;
the coherency of computation is maintained in self-organized mesh networks of components also referenced as hives.

This approach allows high reliability and fault tolerance of the whole metaverse without demanding extensive infrastructure to support its continuous operation.

Implementation of a particular application based on a metaverse requires tailoring a relevant metaverse world model, equipped with a set of off-the-shelf and/or bespoke metaverse agents serving that world model, by running their respective data infusers and maintaining appropriate data distribution.

Metaverse World Models

A fundamental part of the Metaverse implementation is a method of combining data from real world and virtual world sources and generating an accurately fused metaverse world model from that data. So, every given metaverse world model specifies a semi-simulated (e.g. part virtual, part real-world) dynamic physical system characterised and continuously updated to a sufficient extent for minimizing uncertainty in computing the next most probable state of its elements, thus boosting overall robustness of that model and the metaverse as a system in whole.

The elementary building blocks of a metaverse world model are:
“objects” specifying spatially-mapped elements of real and virtual worlds having static (or negligibly slow-changing) and dynamic characteristics including, but not limited to, mass, geometry and mechanical properties along with instantaneous state of location and motion vectors, all forming comprehensive physical information of an object for tracing and computing its states;
“conditions” characterising the ambient environment in whole or in certain spatially-mapped area(s) including, but not limited to, its physical conditions, like gravitational acceleration, and/or certain meteorological data like air temperature, pressure and humidity, lighting conditions, atmospheric precipitations, fog density and range of visibility, bearing of an apparent wind etc;
“events” specifying certain state changes caused by an object's behaviour in given conditions; these designate an aggregated form of system elements' state changes bound by certain causes or purposes (e.g. object manoeuvres, collisions, operation of traffic lights and signs, change of weather conditions, etc.)

In a Metaverse World Model:
There is a real-world source that includes (i) a spatially mapped real-world region, such as a digital twin of a certain venue (e.g. proving ground, road network, racetrack, sports arena) and/or (ii) one or more spatially located digital twins of real objects, such as a full-size vehicle, robot, drone, person or obstacle, all having certain physical characteristics in the above mentioned real-world region;
There is a virtual-world source, e.g the virtual world, that includes (i) a spatially mapped virtual-world region attached to a corresponding real-world region and augmenting it with (ii) one or more spatially located virtual objects, such as vehicles, humans, various obstacles or other items simulating real-world concepts and their behaviour, as well as any feasible fantasy objects, all having certain descriptive physical characteristics in the above mentioned virtual region;
and spatially-mapped conditions and events occurring in the real-world and/or spatially-mapped events and conditions simulated in the virtual-world are then combined into the fused metaverse world model.

As a key integral element, the metaverse world model gives a single unified representation of a global descriptive picture for the whole metaverse, from end-to-end. It allows reconciling differences between the local world models of individual agents when distributing data across the system.

Metaverse Agents

The metaverse agents constitute active type of metaverse objects (real or virtual) that are enabled to share their data within a given metaverse, thus avoiding any need for the excessive computation that would be required for other agents to infer their states and behaviour. Each agent also has its local world model, thus keeping certain “action contexts”, including information about real and virtual elements of the metaverse (objects, conditions and events) that the agent takes into consideration for processing its own states and behaviour. Collectively, agents work as an integral system of sensors and actuators, allowing one to regard the whole metaverse as a composite multi-agent robotic system.

The agents that represent individual, real physical objects, usually some machines and devices, can be implemented as hardware or software components installed and connected into respective configurations of control units and sensors that are specific for such machines and devices. Such integral sets of agent components makes its host-object “metaversed” (i.e. part of the Metaverse platform) by collecting its data and tracking its state, along with using certain sets of data infusers to provide immersion of the host-object into a given metaverse by infusing virtual data into its normal operational data.

Virtual agents provide representations for virtual active objects. Virtual agents may exist within a shared simulation environment, where they share a single consistent local world model. Virtual agents may also be distributed across multiple simulation environments, all running in parallel and maintaining their own local world models.

Each agent can be thought as an apparatus connected to a shared environment of the metaverse for consuming and sharing the metaverse world model data in order to provide coherent data infusion process for its host system. So integrally, the agents maintain that process across the whole metaverse.

The agents are also responsible for handling errors in metaverse processes, thus keeping its operation stable. These are the key concepts related to metaverse error management:
incidents: the events falling out of inferred course of development in metaverse;
anomalies: the unusual conditions that cause chains of successive incidents;
collapse: a situation when a chain of incidents leads to contradictory state of the metaverse, meaning loss of coherency and invalid data infusion.

The robustness of a metaverse application is defined by the following ground rules:
Any incident is automatically handled by metaverse agents, so it does not trigger other incidents;
Any appearing anomaly doesn't cause collapse of the metaverse.

If any of these rules fail for a given metaverse then corresponding application is insufficiently robust.

Data Distribution Framework

The exchange of data in a metaverse needs to occur so that appropriate data infusion happens in real-time and coherently. Furthermore, the representation or display of the metaverse to its end-users should also happen with minimal latency. Due to the heterogenous architectures of the various machines and devices, and the diversity of their internal and external connectivity, actual data distribution becomes a complex problem with multiple factors. The process of data exchange must flow across different networks, wired and wireless, IP-based and non-IP, and through various connectivity protocols, while preserving the coherency capabilities of the system. Even though the evolution of network technologies (e.g. 5G, C-V2X, etc.) provides solutions for low-latency applications in general, there are still certain gaps that require specific solutions.

The Metaverse implementation addresses the above problems with a Data Distribution Framework for implementing metaverse-based applications. This also reduces development time and eases deployment and maintenance of such applications. The components of a Data Distribution Framework decouple metaverse applications from actual connectivity architectures and topologies, thus minimising performance issues caused by defects of application connectivity design.

DDS with Connectivity Enhancements

The Metaverse Data Distribution Framework uses OMG standardised Data Distribution Service (DDS) as middleware of choice for its main tasks, and also introduces a number of enhancements allowing it to overcome a number of problems in an efficient way, without introducing workarounds that may compromise performance and coherency of a given metaverse.

Even though standard DDS provides decentralised, data centric architecture, which gives a perfect basis for exchanging data in a Metaverse world model, it is designed for IP networks only. That is why, among the enhancements provided in the Metaverse implementation, is the method of tunnelling DDS data packets through non-IP networks including, but not limited to, industrial M2M (machine-to-machine) protocols, V2X (vehicle-to-everything), CAN, FlexRay and others. For the communications where DDS tunnelling is not applicable, the Data Distribution Framework provides transparent surrogate connectivity.

On the other hand, the Metaverse Data Distribution Framework does not use DDS for 100% of its connectivity tasks and uses alternative proprietary low-latency protocols for real-time signalling.

Boosted V2X Stack

For applications involving fast-moving vehicles, the Data Distribution Framework provides a special connectivity method with a boosted stack of protocols for Vehicle-to-Everything (V2X) communication that extends the capabilities and performance of existing V2X systems. The boosted stack has the following advanced features:
Ability to broadcast messages as frequently as every 10 milliseconds (against 100-millisecond rate for regular V2X systems);
Extended message format, enabling metaverse-related signalling via V2X radio transparently to regular V2X systems and not affecting their work;
DDS tunnelling over IEEE 802.11p and 3GPP C-V2X;
Universal Over-The-Top (OTT) data transmission via V2X radio for any UDP and TCP connectivity in a transparent way to regular V2X systems without affecting their work.

Data Infusion Framework

Along with data distribution, metaverse agents also run one or more data infusion processes relevant to a particular host-object or host-system the agent is attached to. The Data Infusion Framework embodies an integral set of methods for data infusion and provides an extensible toolkit of reusable software and hardware components designed to provide a standard way to build and deploy data infusers for various control and sensor systems, allowing seamless and accurate infusion of artificial virtual data into normal data conditioned by real physical processes.

Control Data Infusers In the Metaverse implementation, the infusers for control data are designed for various control systems, e.g. vehicle ECUs (electronic control units) and robotic RCUs (robot control units), allowing seamless and accurate infusion of artificial virtual data into normal control data conditioned by real physical processes.

Various machines in a metaverse can have different control systems and data protocols, but this variety may be limited to certain dominant industry standards. The actual implementation of the Metaverse platform contains the following infusers:
DDS Infuser—provides data infusion logic for OMG Data Distribution Service, which is the most native connectivity protocol for the Metaverse platform as stated above. DDS is highly popular in industrial systems, automotive and robotics, so it has become an integral part of the widely used robotic software suite ROS (Robot Operating System). This infuser allows a vast variety of tasks to be infused or ingested, depending on the particular type of machine and the complexity of its internal control data transmitted over DDS between its control units.
V2X Infuser—provides data infusion or ingestion logic for Vehicle-to-Everything (V2X) communication. This includes, but is not limited to, V2V (vehicle-to-vehicle) and V2I (vehicle-to-infrastructure) protocols and applications based on IEEE 802.11p (incl. both ETSI ITS-G5 and WAVE) and 3GPP C-V2X. For instance, this infuser allows virtual vehicles to present themselves over V2V as real vehicles would do.
XCP Infuser—provides data infusion or ingestion logic for an automotive “Universal Measurement and Calibration Protocol” (ASAM MCD-1 XCP) connecting measurement and calibration systems to the vehicle ECUs. The actual implementation of this infuser supports various physical connectivity including, but not limited to, XCP on CAN, Ethernet and FlexRay.

The set of control data infusers is an extensible toolkit and is subject to the further development of the Metaverse platform; more infusers covering the full range of control data protocols will be provided.

Sensor Data Infusers

In the Metaverse implementation, the infusers for sensor data are generally designed for various types of sensors used in robotics and automotive including, but not limited to, radars, LIDARs (“light detection and ranging”), ultrasound, computer vision cameras and stereo vision cameras. In the actual implementation of the Metaverse platform, the sensor data infusion method is based on the plug-in insertion of a sensor data infuser into the signal processing chain of a respective sensor system, which means that the alteration of the data output comes from the primary low-level signal processing modules of these sensor systems, i.e. before that data is received by the high-level processing modules interpreting sensor information.

The Metaverse implementation provides a set of methods designed for various sensor data formats and their data processing systems allowing seamless and accurate infusion of artificial virtual objects and conditions into normal sensor data, reflecting real physical objects and conditions.

One of the important elements of sensor data infusion increasing its realism is the simulation of signal noise and flaws. So that also becomes a part of the respective sensor data infusion methods. The sensor data infusion method support the following forms of digital signals:
image-based sensor signals—any sensors that output 2D serial images, usually with a certain constant frame rate (e.g. video cameras or SAR radars);
sensor signals based on point-clouds—the sensors that output 3D point cloud data (e.g. LIDARs, computer vision systems and stereo-cameras);
sensor signals based on serial data—any sensors that output numeric characteristics in a series of bytes (e.g. ultrasonic sensors, some radars, temperature, velocity sensors, etc.)

Sensor data infusion is not limited to the above algorithms and the method allows tailoring for more specific digital or analogue sensor systems.

High-Level Data Infusers

As a simple surrogate for most of the above methods of data infusion, high-level infusers provide for the incorporation of virtual data to the high-level system of a machine (e.g. ADS software) without altering any lower level data of its control and sensor units. This method allows easier integration of metaverse agents into the machine, but brings certain compromises into the overall pseudo-realism of such a metaverse implementation. This kind of data infusion method operates by injecting already classified and characterised objects, just as this was done from interpreting sensor and/or control data. This method works well for scenarios where end-to-end simulation of the virtual objects, conditions and events is not required.

Representation Framework

The Metaverse implementation is not tailored for specific tools of human interaction. To the contrary, it is designed to be capable of integration with any existing and future user interfaces including, but not limited to, single or multi-screen video displays, mobile terminals and remote controllers, VR/AR headsets, interfaces with user motion trackers, direct manipulation and tangible interfaces. This is achieved by a software integration toolkit having a multi-layered structure of metaverse world model representations, where various properties of objects have a certain affinity to specific representation layers. Each of these layers can be assigned to a specific representation method, also referred to as a channel, which is served by specific user interface components and respective devices.

Practical Implementation

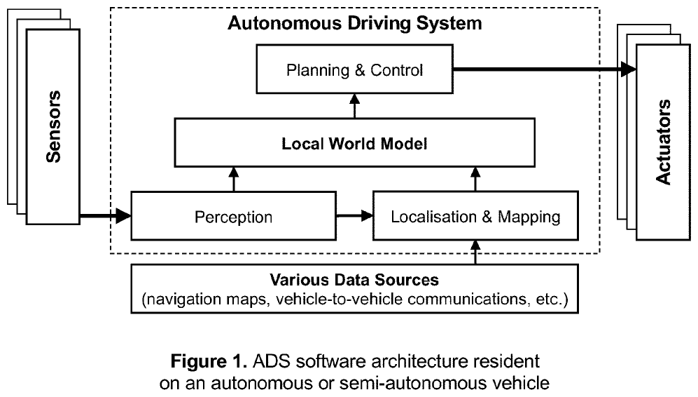

FIG. 1 below shows the high-level architecture of a typical autonomous or semi-autonomous vehicle. Various sensors (e.g. LIDAR, computer vision, radar) feed data to a Perception sub-system which identifies and tracks objects, nearby vehicles, the road ahead and the general environment sensed by the sensors. The Perception sub-system forms data for a Local World Model and interoperates with a coupled Localisation and Mapping sub-system.

Other data sources (e.g. map data, vehicle to vehicle communications) are shared with the Localisation and Mapping sub-system, which in turn also feeds the Local World Model. The Local World Model integrates or combines all the incoming data into a single coherent, spatially-mapped view of all the data inputs; it then provides data to the Planning and Control sub-system, which performs dynamic path planning, taking into account all of the data sent to it, and controls the vehicle actuators (e.g. brakes, steering, accelerometer; indicator lights etc.).

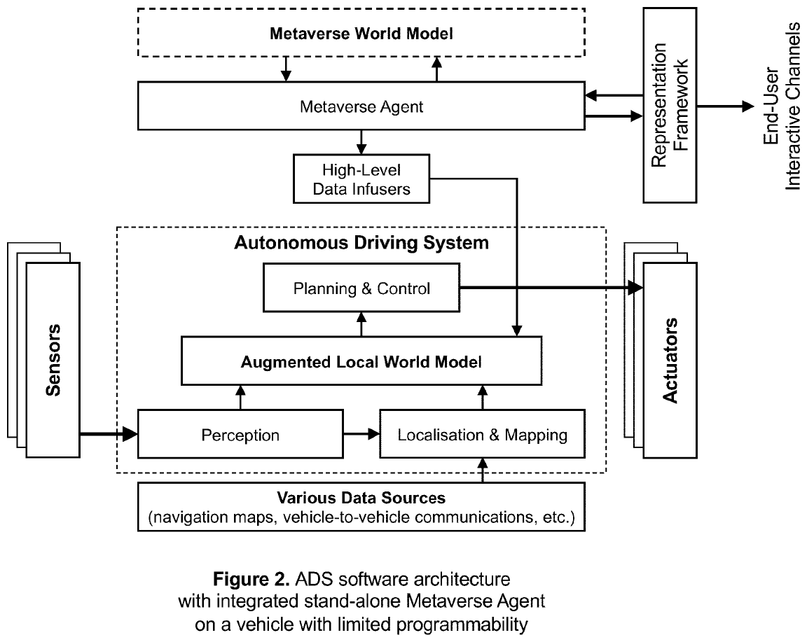

FIG. 2 shows integration of the Roborace Metaverse platform within an autonomous driving system of a vehicle with limited, accessible programmability, such as a mass produce cars like Toyota Prius® that have essential drive-by-wire capability and that's why widely used for the development of self-driving platforms. In addition to the ADS software architecture shown in FIG. 1, we now have the basic elements of the Metaverse platform, namely a Metaverse World Model, also referred to as a ‘virtual world’; into this model are added the virtual objects, events or conditions that are to be fused with the data from the conventional sensors and other data sources in the vehicle, e.g. to test how well the ADS copes with these objects, events or conditions. This Metaverse World Model is entirely separate from and independent of the pre-existing local World Model in the vehicle. It captures virtual data that has been generated outside of the vehicle or generated onboard independently of the operation of the vehicle, and that is spatially-mapped in the Metaverse World Model. The World Model sends data to a Metaverse Agent sub-system, which tracks the objects, events and conditions injected into the World Model, and provides an output to the High-Level Data Infusers sub-system, which process the objects, events and conditions to a format that is compatible with the Local World Model that aggregates data from the vehicle's sensors and other data sources. In this way, virtual objects, events and conditions are input to the vehicle ADS and treated as though they were other data sources, equivalent to the pre-existing data sources in the vehicle, like the LIDAR, radar and computer vision sub-systems without touching these systems even if they're present in the vehicle. The Metaverse Agent sub-system also provides an output to the Representation Framework, so that the virtual objects, events or conditions can be visually represented to end-users, e.g. audiences watching an interactive video streaming service, such as an eSports channel, or a TV broadcast.

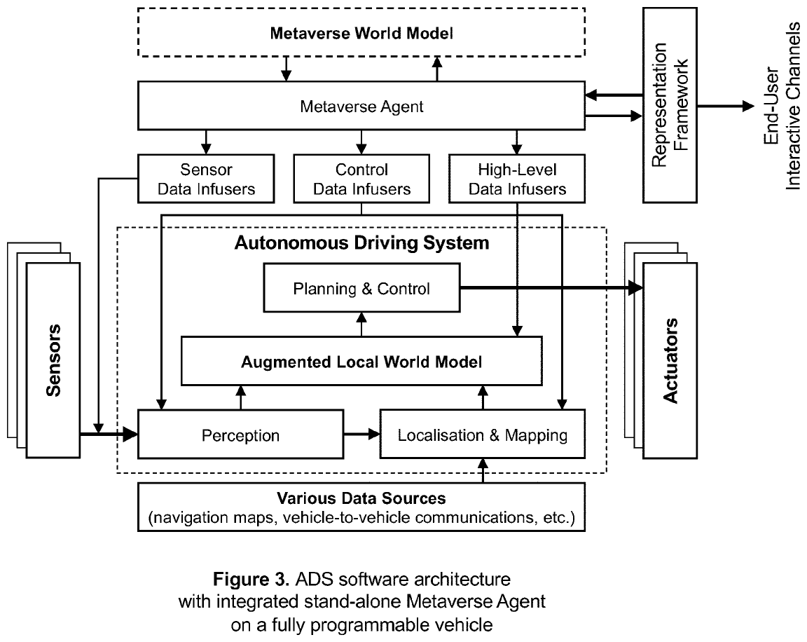

FIG. 3 shows the ADS software architecture with integrated stand-alone Metaverse Agent on a fully programmable vehicle, such as the Robocar® autonomous racing vehicle having a fully-fledged drive-by-wire platform and fully-accessible comprehensive system of sensors like cameras, LIDARs, radars, computer vision, ultrasound, etc. This builds on top of the basic system described in FIG. 2. In addition to the high-level virtual data that is created in the FIG. 2 system, we now create virtual sensor data in the World Model and this virtual data is then sent, via the Sensor Data Infuser sub-system to integrate with the sensor data from the vehicle's pre-existing sensors. We also create virtual control data in the World Model and this virtual data is then sent, via the Control Data Infuser sub-system to integrate with the control data in the Perception sub-system and also the Localisation and Mapping sub-system.

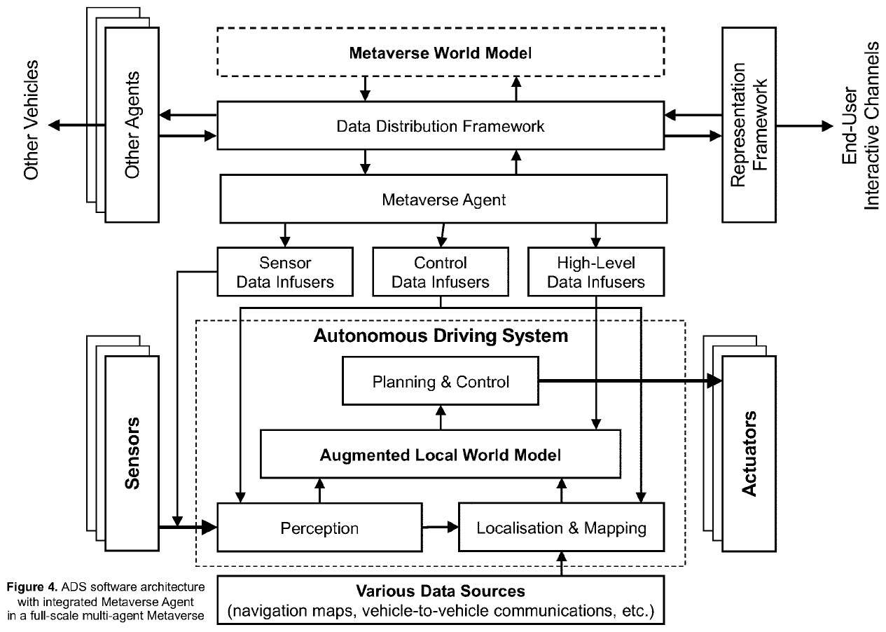

FIG. 4 shows the FIG. 3 system, now further enhanced with collective data exchange with other Agents; this system is the full multi-Agent Metaverse implementation. In the FIG. 3, single Agent implementation, the single Agent in effect relates to just a single vehicle. But autonomous or semi-autonomous vehicles will share data with nearby vehicles for greater situational awareness and to enable new co-operative driving modes, like forming long chains of closely spaced vehicles with closely synchronized speed, overtaking each other and doing other manoeuvers against other vehicles or objects in various conditions. To model this, a full multi-Agent Metaverse implementation is required, in which the Agents share a common Metaverse World model and each Agent in effect models the virtual sensory and control data generated by these nearby real or virtual vehicles and objects, as shown in FIG. 4.

Use Cases

To move now to use cases, one example, implemented by the Roborace® platform and proven in the field, implements a Metaverse autonomous vehicle testing and racing program, where the basic representation layer can be a set of video-streams transmitted from cameras installed on the racetrack and giving various points of view (as traditional framed video or/and stereoscopic 360-view). So this layer provides a sufficient representation of all real objects figuring in this metaverse. On top of this basic layer there can be one or more representation layers (overlays) visualising the virtual objects for various media channels. So a particular representation of a metaverse world model can be rendered as a 3D-scene in a real-time graphics engine like Unreal Engine, Unity, CryEngine or anything else. These virtual overlays can be applied to the underlying video streams using appropriate tools, including real-time video insertion tools, corresponding devices and user-interfaces, so that all become a blended scene for the audience. The Metaverse Representation Framework provide sufficient data for this process and also ensures full coherency for this process.

Virtual objects can include virtual obstacles or conditions that are a consistent or permanent feature of the race track or racing area; this enables an engineer or test circuit designer to add interesting and demanding features to the race or proving track that would be very expensive (and perhaps impossible) to build in the real world, such as very extreme chicanes, skid pans, ice tracks etc. The autonomous vehicle planning and control system can hence be rapidly tested and evaluated (for example against mandatory government performance regulations embodied in the virtual world testing regime).

Virtual objects can include virtual obstacles or conditions that are suddenly introduced and are transient and may be static or may even move—e.g. a virtual child running across the road, or a virtual vehicle spinning out of control ahead. Rapid identification of the virtual child running across the road, or a virtual vehicle spinning out of control ahead, requires the autonomous vehicle to make complex and near instantaneous identification, tracking and assessment of the new dangers and to dynamically re-plan a route and/or take emergency braking action, taking into account vehicle dynamics (e.g. braking or acceleration capability with given tyres in the specific weather and road surface conditions; vehicle stability under sudden directional changes) avoiding all nearby real and virtual vehicles, road barriers etc, so requiring complete situational awareness from all sensors and the ability to make rapid, dynamic trade-offs between competing scenarios. Different robotic ‘ethics’ planning systems can be tested—for example, exploring how audiences react in reality if a vehicle, in avoiding a virtual child running across the track, swerves to avoid that child but risks colliding with a nearby real-world car in doing so.

At a slower pace, the vehicles could be delivery drones moving at no more than 5 or 10 km per hour, and the virtual objects could include the typical objects a delivery drone would encounter, such as a pedestrians, cyclists, pets, cars. Again, the platform enables rapid testing and evaluation of the drone's ability to rapidly identify, track and assess its continuously changing environment and to make complex rapid, dynamic trade-offs between competing scenarios.

Software algorithm upgrades and changes can be rapidly provided and tested out in these hybrid real-world and virtual world scenarios, greatly increasing the rapidity of algorithm improvement and testing against a far broader range of scenarios than would be possible with testing limited to real-world only testing. In a competition scenario, rather than a vehicle testing and development scenario, virtual objects could be introduced by audience or spectators to challenge some or all of the vehicles; races between real-world vehicles could be made far more interesting and demanding if say the leading vehicle was presented with a specific challenge, like a virtual animal crossing its path, and if that vehicle fails to successfully avoid the animal, then it is automatically required to move to second place or suffer some other penalty; whereas if it does successfully avoid the animal, it could be given some bonus points or some other reward. That virtual obstacle could be added by a TV or broadcast director to give added interest and excitement, or fans of other teams or vehicles could purchase points on-line that can be spent in buying these obstacles to place in front of their competitors.

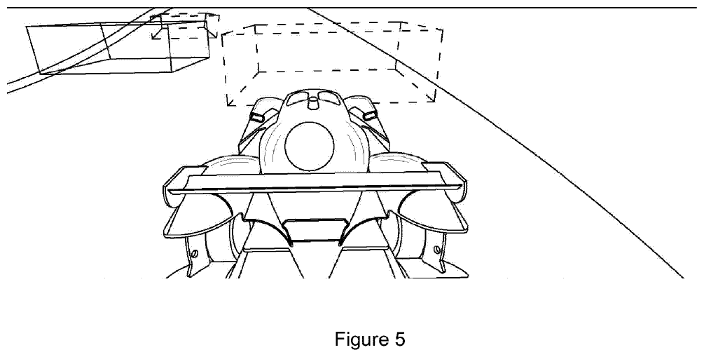

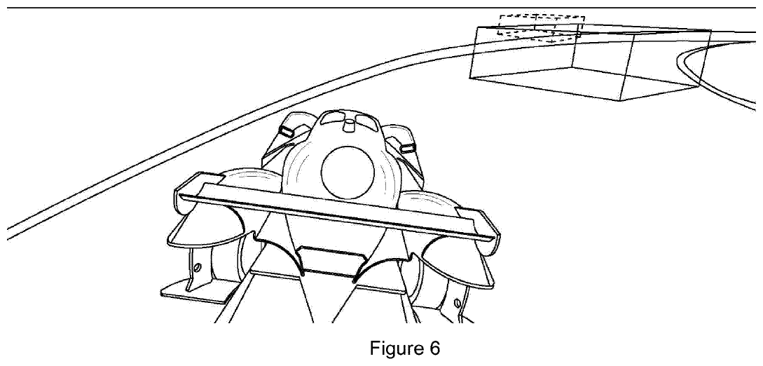

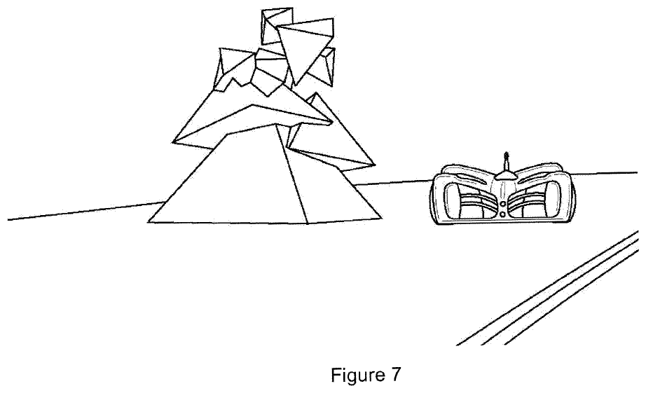

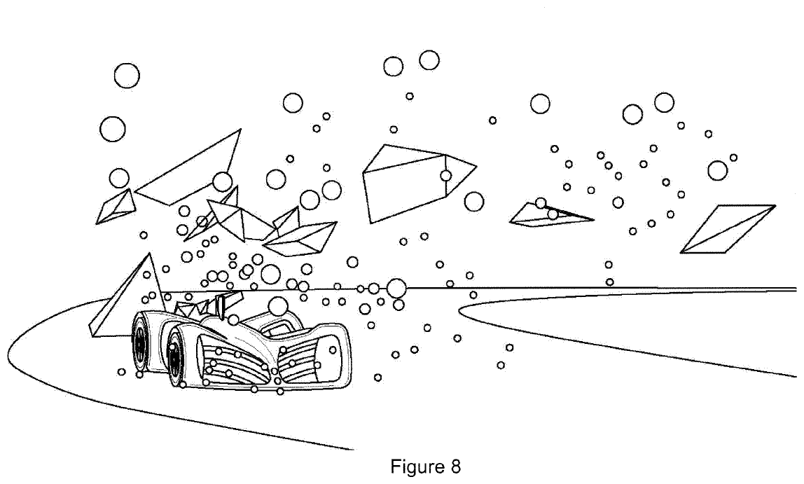

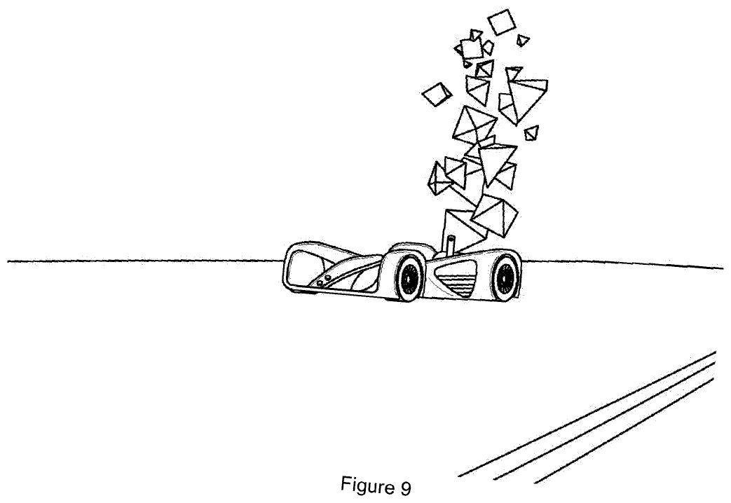

Virtual objects can include virtual obstacles or conditions that are suddenly introduced and are not to be avoided, but instead passed through, (e.g. earning the vehicle bonus points in a competition; or defining an optimal path or route and hence improve the obstacle avoidance performance). These virtual rewards (referred to earlier as ‘loots’) that a vehicle has to pass through to earn rewards/points or not suffer penalties could be added by a TV or broadcast director, or bought by fans of that vehicle. FIGS. 5 and 6 show a racetrack with virtual obstacles to be avoided shown as boxes with solid lines, and regions to be driven through shown as boxes with dotted lines. This point-of-view could be sent as part of an eSport or TV broadcast. In practice, the audience would not be shown these bounding boxes, but instead something visually appropriate. FIG. 7 shows how this audience could be shown a racetrack with a large virtual obstacle placed on the track; the vehicle is shown avoiding the obstacle. FIG. 8 shows what happens if the vehicle drives through the virtual obstacle, with the virtual object, programmed with suitable physics, reacting to the impact by disintegrating, with debris shown flying dramatically across the race track. FIG. 9 shows a similar case with possible visualisation of a loot reward that has been caught by being driven through; the loot then explodes vertically.

The system is not limited to autonomous vehicles; it could also for example be used in conventional F1 or Formula E motor sports, where virtual obstacles or loots are added by a race controller, or by audience voting etc. and the human driver has a head up display or augmented reality glasses that can display the virtual obstacles or loots that have been added. In this variant, the data fusion system would include the in-vehicle LIDAR, stereo cameras and other sensors that are mapping the route ahead and the local environment, so that the head up display or augmented reality glasses captures and displays an accurate view (which could be simplified or photo-realistic or actual real-time video) of the path ahead and other cars that are in the field of view. The data fusion system would then ensure that the virtual objects (e.g. obstacles or rewards/loots) are shown on the head-up display or augmented reality glasses, correctly positioned on (or in relation to) the route ahead, so that the driver clearly sees them and can steer to avoid them (in the case of obstacles) or through them (in the case of loots). A viewer at home would see the real-world cars racing along the real-world track, and super-imposed on the track using real-time video insertion technology, the virtual obstacles or rewards; if the driver passes through an obstacle or reward, then (as shown in FIGS. 8-9), appropriate animation of the virtual obstacle or rewards occurs.

Key Features

We can generalise the core features of the Metaverse platform as follows:

A. A data fusion system for use in a real-world vehicle, in which the vehicle includes multiple data sources that generate sensor data that is spatially-mapped to a real-world region; and in which the data fusion system is configured to fuse or integrate (i) the spatially-mapped sensor data with (ii) virtual data, that has been generated outside of the vehicle or, whether inside of or outside the vehicle, has been generated independently of the vehicle or the operation of the vehicle, and is spatially-mapped to a virtual world.

B. A vehicle that includes a data fusion system as defined above.

C. A method of developing, improving or testing a vehicle, in which the vehicle includes a data fusion system as defined above and virtual objects, events or conditions are added to the virtual world processed by the data fusion system to test how the vehicle responds to those virtual objects, events or conditions.

D. A vehicle that has been developed, improved or tested using the method defined above.

E. A game or other entertainment system, the system generating images that display or otherwise feature a vehicle that includes a data fusion system as defined above.

We can organise the subsidiary features into the following 13 areas. Note that any subsidiary feature can be combined with any other subsidiary feature, and all the main features listed above can be combined with any one or more of these subsidiary features.
Data fusion
World model
Virtual world
Real-world
Agents
Data Distribution Framework
Data Infusion Framework
Data Infusers
Representation Framework
Vehicle control
Vehicle
Audience experience
Competition formats

Data Fusion
The data fusion system in which the data sources generate control data and in which the data fusion system is further configured to fuse or integrate the control data as well as the sensor data with the virtual data.
The data fusion system in which the fused or integrated (i) sensor data and/or control data and (ii) the virtual data is supplied to a real-world vehicle control system that controls the vehicle in dependence on that fused or integrated data input.
The data fusion system in which the vehicle is configured to respond autonomously to the fused or integrated (i) spatially-mapped sensor data and/or control data and (ii) the spatially-mapped virtual data.
Data generated by the vehicle control system is also fused or integrated with (i) the sensor data and/or control data and (ii) the virtual data.
Data fusion or integration takes places with near zero latency.
Data handling components (“data infusers”) perform the function of fusing or integrating the sensor data with the virtual data.
Data handling components (“data infusers”) perform the function of any of: (i) handling the virtual data; (ii) passing that virtual data into vehicle sub-systems that handle the sensor data and/or control data so that the virtual data can be fused, merged or integrated with the sensor data and/or control data and/or an ADS Local World Model.

World Model (e.g. the Augmented Local World Model in FIGS. 2, 3 and 4)
The data fusion system fuses or integrates into a single world model the (i) sensor data and/or control data and (ii) the virtual data.
The single world model is a fused spatially-mapped world that is a single unified representation of a global state that reconciles any differences in (i) the sensor data and/or control data and (ii) the virtual data.
The data fusion system uses a world model that is generated from (i) a real-world source or sources, including a spatially mapped real-world region and (ii) a virtual world source or sources, including a spatially mapped virtual-world region that corresponds to the real-world region.
The world model is resident or stored in memory that is (i) wholly in the vehicle or (ii) is distributed between in-vehicle memory and memory external to the vehicle, or (iii) is wholly outside of the vehicle.
The world model comprises one or more of the following: objects, conditions and events; where objects specify spatially-mapped elements or things in the real and virtual worlds; conditions characterise the ambient environment in spatially-mapped regions of the real and virtual worlds; and events specify how objects behave or react in defined circumstances.
The data fusion system predicts the next most probable state of an object in the world model
The next most probable state of an object in the world model is predicted using one or more of the following techniques: dead reckoning, methods of mathematical extrapolation, Kalman filtering, deep learning inference and specific problem-solving methods like Pacejka models for vehicle tyre dynamics or SLAM for localisation in unknown environments.
The data fusion system performs real-time data processing and computation of the next most probable state, but only for those objects that are momentarily involved in actions that modify or form a local world model.

Virtual World (e.g. the Metaverse World Model in FIGS. 2, 3 and 4)
The spatially-mapped virtual data is generated within a spatially-mapped virtual world.
The virtual world is created in a system that is external to the vehicle systems, is controlled independently of the vehicle and is not generated by the vehicle or any sensor or control systems in the vehicle.
The virtual world resides wholly externally to the vehicle and shares the same spatial mapping or otherwise corresponds to the world model that is resident or stored in memory that is (i) wholly in the vehicle or (ii) is distributed between in-vehicle memory and memory external to the vehicle, or i(iii) s wholly outside of the vehicle.
The virtual data includes data that mirrors, spatially matches or spatially elates at least in part to the world in which the vehicle moves or operates.
The virtual data includes one or more of events, conditions or objects which present, or provide data to be fused with data from, some or all of the in-vehicle sensors so that the in-vehicle sensors react as though they are actual real-world events, conditions or objects.
The virtual data includes one or more of events, conditions or objects which present to a real-world vehicle control system as though they are actual events, conditions or objects detected by some or all of the in-vehicle sensors.
The virtual data includes one or more of events, conditions or objects which are added in order to test how effectively the real-world vehicle control system reacts to the events, conditions or objects.
The virtual data includes objects which the vehicle has to avoid, such as virtual people, cones, barriers, signage, buildings, or other vehicles.
The virtual data includes objects and/or conditions which the vehicle has to react to, such as rain, fog, ice, uneven road surfaces.
The virtual data includes objects which the vehicle has to pass through, such as loots, route paths, intersections, entrances and exits.
The virtual data includes objects or loots which the vehicle has to pass through in order to earn points in a race, game or competition.
The virtual data includes objects or loots which the vehicle has to pass through in order to earn points in a race, game or competition and these are positioned close to virtual or real objects which the vehicle has to avoid, such as virtual people, barriers, signage, or other vehicles.
The virtual data includes objects and/or conditions to form part of a media entertainment, such as eSports streaming, television, games, film.
The virtual data includes one or more of objects and/or conditions to form part of a vehicle testing or development program.

Real-World
The data fusion system processes data that includes any of the following: the real-world locations of other vehicles, robots, drones and people, the local topography, the route or road the vehicle is travelling along, any other the status of traffic lights, the time of day, weather conditions, type of road, weather, location of parking bays, and garages.

Agents
Agents are responsible for tracking objects, events and condition added or injected into the world model.
Agents have their own local world model that tracks the objects, events or conditions relevant to the state and behaviour of each agent.
Agents share their state and behaviour with other agents.
Agents are responsible for tracking objects, events and condition added or injected into the world model.
Agents are responsible for handling errors.
A single agent corresponds to or represents a single virtual vehicle.
The world model comprises a multi-agent system including multiple virtual vehicles and other objects.

Data Distribution Framework
The data fusion system uses a decentralised, data centric architecture, such as an OMG

DDS framework, to handle or transfer one or more of the sensor data, control data and the virtual data.
Tunnelling DDS data packets are tunnelled through non-IP networks including, but not limited to, industrial M2M (machine-to-machine) protocols, V2X (vehicle-to-everything), CAN, FlexRay and others.
For fast-moving vehicles, a data distribution framework provides a connectivity method with a boosted stack of protocols for Vehicle-to-Everything (V2X) communication that extends the capabilities and performance of existing V2X systems with one or more of the following features: Ability to broadcast messages as frequent as every 10 milliseconds; extended message format enabling signalling via V2X radio transparently to regular V2X systems and not affecting their work; DDS tunnelling over IEEE 802.11p and 3GPP C-V2X; Universal Over-The-Top (OTT) data transmission via V2X radio for any UDP and TCP connectivity in a transparent way to regular V2X systems without affecting their work.

Data Infusion Framework
The data fusion system uses an extensible toolkit of reusable software and hardware components designed to provide a standard way to build and deploy real-time data infusers for various control and sensor systems allowing infusion of artificial virtual data into normal data.
Provides data infusion logic for OMG Data Distribution Service.
Provides data infusion logic for Vehicle-to-Everything (V2X) communication.
Provides data infusion logic for automotive “Universal Measurement and Calibration Protocol” (e.g. ASAM MCD-1 XCP) connecting measurement and calibration systems to vehicle ECUs.

Data Infusers
The data fusion system includes data infusers, which are plug-in components for ingesting data that represents any of the following virtual data: virtual objects, conditions or events.
Data infusers supply or provide virtual data to be fused with real-world sensor and/or control data.
The data fusion system includes data infusers, which are plug-in components for ingesting data that represents (i) sensor and/or control data; (ii) and/or any of the following virtual data: virtual objects, conditions or events.
Data infusers fuse or integrate virtual data with real-world sensor and/or control data.
Data infusers provide data to a real-world vehicle control system that processes (i) the virtual data, or (ii) the fused or integrated virtual and sensor and/or control data, as real data or equivalent to real-world data.
Data infuser components maintain their data sampling rates and resolution independently of one another.
Coherency of computation is maintained in self-organized mesh networks of data infuser components.
Infusers for processing sensor data are specifically designed for various types of sensors used in robotics and automotive including, but not limited to, radars, LIDARs ultrasound, computer vision, and stereo vision cameras.
The sensor data includes: image-based sensor signals, including any sensors that output 2D serial images; sensor signals based on point-clouds, including data from LIDARs and stereo-cameras; sensor signals based on serial data, including ultrasonic sensors, radar, temperature, and velocity sensors.

Representation Framework
The data fusion system includes a representation framework, which is an extensible toolkit of reusable software integration adaptors providing an immersive representation of the virtual world and/or fused world, namely the world created by fusing the data from the real world data sources and the virtual data, to end-users via user interfaces, and/or interactive platforms and/or devices.
The representation framework is capable of integration with user interfaces including, but not limited to, single- or multi-screen video displays, mobile terminals and remote controllers, VR/AR headsets, user motion trackers, direct manipulation and tangible interfaces.
The representation framework includes a software integration toolkit having a multi-layered structure of world model representations, where various properties of objects have affinities to specific representation layers and each of these layers can be assigned to a specific representation method, which is served by specific user interface components and respective devices.
A basic representation layer is a set of video-streams transmitted from cameras installed on a real-world vehicle racetrack and giving various points of view, and on top of this basic layer there are one or more representation layers or overlays visualising virtual objects for various media channels, and these virtual overlays are be applied to the underlying video streams using appropriate tools, devices and user-interfaces, so that a blended scene results that combines real and virtual objects.

Vehicle Control
Vehicle includes a real-world Automated Driving System (ADS) planning and control system that controls or actuates systems in the vehicle, such as steering, brakes, accelerometer and that real-world planning and control system takes inputs from the data fusion system.
Vehicle includes an ADS that generates a local world model that processes real-world data, and the ADS provides input data to the data fusion system, which in turn provides input data to a real-world planning and control system (“ADS Planning and Control layer”).
The local world model in the ADS sends data to, and the ADS Planning and Control layer receives data from, an external world model or virtual world.
The local world model in the ADS sends data to and the ADS Planning and Control layer receives data from, a world model that is an embedded portion or sub-system of the ADS.
The local world model in the ADS sends data to, and the ADS Planning and Control layer receives data from, both an external world model and also a world model that is an embedded portion or sub-system of the ADS.
The world model enables the injection of any of the following: virtual objects, virtual paths, virtual routes, into the ADS which the ADS then includes in its control and planning operations.
The local world model sends data over an OMG DDS databus or similar real-time communication middleware.
The output of the world model matches the expected inputs of the ADS Planning and Control normally received from the local world model and in this mode the ADS Planning and Control has no indication whether an object is real or virtual.
The output of the World Model matches the expected inputs of the ADS Planning and Control normally received from the local world model with additional flags that indicate whether an object is real or virtual and in this mode the ADS Planning and Control system is adapted to take advantage of this additional object information.

Vehicle
Vehicle is a car, plane, land vehicle, delivery vehicle, bus, sea vehicle, drone, robot, or other self-propelled device—e.g. a non-autonomous vehicle.
Vehicle is an autonomous car, plane, land vehicle, delivery vehicle, bus, sea vehicle, drone, robot, or other self-propelled device.
Vehicle is a racing vehicle.
Vehicle is one of several mechanically similar racing vehicles with each have different control systems or software sub-systems for those control systems, and the different vehicles compete to react in an optimal manner to the same new virtual data supplied to each of them.
Vehicle is an autonomous car, plane, vehicle, drone, robot, or other self-propelled device configured to film or record other vehicles that are racing.
Vehicle is driven or piloted by a human and a display in the vehicle shows some or all of the virtual world to that human driver or pilot.

Audience Experience
A spectator, viewer, participant or controller of an event featuring the vehicle(s) is able to view, on a display, both the real-world vehicle and any objects generated in the virtual world, such as objects or conditions which the vehicle interacts with.
A spectator, viewer, participant or controller of an event featuring the vehicle(s) is able to view both the real-world vehicle and, on a display, such as an augmented reality headset or glasses, any objects generated in the virtual world, such as objects or conditions which the vehicle interacts with.
A spectator, viewer, participant or controller of an event featuring the vehicle(s) is able to navigate through the fused real and virtual worlds to alter their view of that fused world.
A spectator, viewer, participant or controller is able to navigate through the fused real and virtual worlds to alter the view of that fused world that they are viewing, filming or recording or streaming.
A spectator, viewer, participant or controller of an event featuring the vehicle(s) is able to add or control in the virtual world any one or more of the following: (a) objects which are added in order to test how effectively the real-world control system reacts to the objects; (b) objects which the vehicle has to avoid, such as virtual people, barriers, signage, or other vehicles.
A spectator, viewer, participant or controller of an event featuring the vehicle(s) is able to add or control in the virtual world objects which the vehicle has to pass through, such as loots, route paths, entrances and exits.
A spectator, viewer, participant or controller of an event featuring the vehicle(s) is able to add or control in the virtual world objects or loots which the vehicle has to pass through in order to earn points in a race, game or competition.
A spectator, viewer, participant or controller of an event featuring the vehicle(s) is able to add or control in the virtual world objects or loots which the vehicle has to pass through in order to earn points in a race, game or competition and these are positioned close to virtual or real objects which the vehicle has to avoid, such as virtual people, barriers, signage, or other vehicles.

Competition Formats
an AV or human-driven real-world vehicle, or AI-assisted human-driven real-world vehicle, races in a real-world driving region; and there is (i) a virtual-world representation of that real-world driving region, and (ii) a virtual vehicle racing against the real-world vehicle, and in which the real-world vehicle reacts to the virtual vehicle as though the virtual vehicle is present in the real-world and the virtual vehicle reacts to the real-world vehicle as though the real-world vehicle is present in the virtual-world.
There is a real-world, full size vehicle in a real-world driving region and also a virtual-world representation of that real-world driving region, and in which the real-world vehicle reacts to control inputs from a user in a simulator or wearing an AR or VR headset.
Self-driving cars compete against virtual cars controlled by eSports gamers safely located inside driver-in-the-loop simulators.
Human drivers with augmented reality displays compete against virtual vehicles controlled by eSports gamers safely located inside driver-in-the-loop simulators.
eSports gamers in simulators directly control physical cars at various levels of control abstraction; operational, tactical and strategic depending upon communication latencies.
Several mechanically similar racing vehicles with each have different control systems or software sub-systems for those control systems compete against one another to react in an optimal manner to the same new virtual data supplied to each of them.

1. A data fusion system for use in a real-world vehicle, in which the vehicle includes multiple in-vehicle sensors that generate spatially-mapped sensor data that is spatially-mapped to a real-world region; and in which the data fusion system is configured to fuse or integrate (i) the spatially-mapped sensor data with (ii) virtual data that has been generated outside of the vehicle or, whether inside or outside of the vehicle, has been generated independently of the vehicle or the operation of the vehicle, and is also spatially-mapped to a virtual world;
and in which the virtual data includes one or more of: events, conditions or objects which each present, or provide data to be fused with data from, some or all of the in-vehicle sensors so that the in-vehicle sensors react as though they are actual real-world events, conditions or objects;
and where objects specify spatially-mapped elements or things in the real and virtual worlds; conditions characterise the ambient environment in spatially-mapped regions of the real and virtual worlds; and events specify how objects behave or react in defined circumstances.

2. The data fusion system of claim 1 in which there are data sources that generate control data and in which the data fusion system is further configured to fuse or integrate the control data, as well as the sensor data, with the virtual data.

3. The data fusion system of claim 1 in which fused or integrated (i) sensor data and/or control data and (ii) the virtual data is supplied to a real-world vehicle control system that controls the vehicle in dependence on that fused or integrated data input.

4. The data fusion system of claim 1 in which the vehicle is configured to respond autonomously to the fused or integrated (i) sensor data and/or control data and (ii) the virtual data.

5-7. (canceled)

8. The data fusion system of claim 1 which fuses or integrates into a single world model the (i) sensor data and/or control data and (ii) the virtual data.

9. The data fusion system of preceding claim 8 in which the single world model is a fused spatially-mapped world that is a single unified representation of a global state that reconciles any differences in (i) the sensor data and/or control data and (ii) the virtual data.

10. The data fusion system of claim 8 which uses a world model that is generated from (i) a real-world source or sources, including a spatially mapped real-world region and (ii) a virtual world source or sources, including a spatially mapped virtual-world region that corresponds to the real-world region.

11-21. (canceled)

22. The data fusion system of claim 1 in which the virtual data includes one or more of events, conditions or objects which are added in order to test how effectively the real-world vehicle control or planning and control system reacts to the events, conditions or objects.

23. The data fusion system of claim 1 in which the virtual data includes objects which the vehicle has to avoid, such as virtual people, cones, barriers, signage, buildings, or other vehicles.

24. The data fusion system of claim 1 in which the virtual data includes objects and/or conditions which the vehicle has to react to, such as rain, fog, ice, uneven road surfaces.

25. The data fusion system of claim 1 in which the virtual data includes objects or loots which the vehicle has to pass through, such as route paths, intersections, entrances and exits.

26. The data fusion system of claim 1 in which the virtual data includes objects or loots which the vehicle has to pass through in order to earn points in a race, game or competition.

27. The data fusion system of claim 1 in which the virtual data includes objects or loots which the vehicle has to pass through in order to earn points in a race, game or competition and these are positioned close to virtual or real objects which the vehicle has to avoid, such as virtual people, barriers, signage, or other vehicles.

28. The data fusion system of claim 1 in which the virtual data includes objects or loots and/or conditions to form part of a media entertainment, such as eSports streaming, television, games, film.

29. The data fusion system of claim 1 in which the virtual data includes one or more of objects and/or conditions to form part of a vehicle testing or development program.

30. The data fusion system of claim 1 which processes data that includes any of the following: the real-world locations of other vehicles, robots, drones and people, the local topography, the route or road the vehicle is travelling along, any other the status of traffic lights, the time of day, weather conditions, type of road, weather, location of parking bays, and garages.

31-64. (canceled)

65. The data fusion system of claim 1 configured to work with a vehicle that is a car, plane, land vehicle, delivery vehicle, bus, sea vehicle, drone, robot, or other self-propelled device.

66. The data fusion system of preceding claim 65 where the vehicle is an autonomous car, plane, land vehicle, delivery vehicle, bus, sea vehicle, drone, robot, or other self-propelled device.

67. The data fusion system of claim 65 where the vehicle is a racing vehicle.

68. The data fusion system of claim 65 where the vehicle is one of several mechanically similar racing vehicles with each have different control systems or software sub-systems for those control systems, and the different vehicles compete to react in an optimal manner to the same new virtual data supplied to each of them.

69-78. (canceled)

79. A vehicle that includes a data fusion system as defined in claim 1.

80. A method of developing, improving or testing a vehicle, in which the vehicle includes a data fusion system as defined in claim 1 and virtual objects, events or conditions are added to the virtual world processed by the data fusion system to test how the vehicle responds to those virtual objects, events or conditions.

81-105. (canceled)
